(19) United States
(12) Patent Application Publication
(10) Pub. No.: US 2012/0209641 A1
(43) Pub. Date: Aug. 16, 2012

(54) EVENT OPERATING SYSTEM USING MULTIFUNCTIONAL CHARACTER SOUVENIR AND EVENT OPERATING METHOD UTILIZING SAME

(76) Inventor: Kyung Mo AHN, Seoul (KR)

(21) Appl. No.: 13/504,202

(22) PCT Filed: Oct. 26, 2010
(86) PCT No.: PCT/KR2010/007387

§ 371 Date: Apr. 26, 2012

(30) Foreign Application Priority Data
Oct. 26, 2009 (KR) 10-2009-0101627

(51) Int. Cl. G06Q 10/02; G06K 7/01

(52) U.S. Cl. 705/5; 340/10.1

(57) ABSTRACT

Disclosed are a system for operating an event using a multi-functional character souvenir and a method for operating the event using the same. The system includes a character souvenir including a Radio Frequency IDentification (RFID) tag device, an information storage chip, a cash charging chip, and an acoustic output device; a composite reader reading and processing data information and cash charging information stored in the character souvenir, and including an information receiver, an information transmitter, and a settlement processor; and an event operator server receiving, storing, and managing the data information read and processed by the composite reader. The method includes an event participation requesting step, a price charge requesting step, an information inputting step, a cash charging step, an event affiliated corporation establishing step, a visitor participation information collecting step, a festival result information processing step, and a post marketing step.

### BACKGROUND OF THE INVENTION

1. Field of the Invention

The present invention relates to a system for operating an event and a method for operating an event using the same. More particularly, the present invention relates to a system for operating an event using a multi-functional character souvenir, which can systematically control and manage a series of event procedures by using an automatic communication control system to more effectively carry out the event when holding large-scale events such as various local festivals, cultural events, exhibitions/expositions or other international conferences, and a method for operating an event using the same.

2. Description of the Related Art

In modern society, a local festival serves as a cultural industry that creates a tourism profit beyond a simple cultural activity of seeing and enjoying and has become a base for developing creative and independent local cultures.

For example, the local festival may provide not only an economical effect, such as increase in local income by foreign visitors, job creation and increase in local tax revenue, but also cultural communication between local areas, and promotion of pride and cultural awareness of local people. Hwacheon Sancheoneo Ice Festival, Hampyung butterfly Festival, and Moongyung Apple Festival are representative successful examples of domestic festivals that sufficiently obtain the foregoing effects.

However, in a conventional local festival generally carried out in each local, the host simply announces the open of the local festival through various types of mass media or on-line media, and propagates the subject of the festival, wonderful things to see, or the menu of foods in terms of the advertisement to increase the number of visitors. Therefore, problems may occur in operation of the festival because the host cannot scientifically manage the visitors and corporations participated in the festival through the numeric statistic and cannot systemically manage a series of events for improving the profit through the efficient marketing

For example, it is impossible to obtain the statistic regarding the local distribution of the visitors participated in the festival, the total number of the visitors, and participation information of individual visitors (visiting years and visiting frequency of the visitors participated in this festival). In addition, the estimation regarding whether the festival succeeds or fails (in case that the festival is carried out only for local people) is inexact. Furthermore, there is no scientific marketing scheme (endowment of benefit and commemorative items) for inducing revisitation of the visitors when holding the next event. Moreover, there is no systemic management and systemic marketing for local corporations participated in the festival.

Meanwhile, recently, a technology available in the foregoing local festival has been suggested. For instance, applicant of the subject application has filed “CONVENTION CARD WITH MULTI-FUNCTIONAL ELECTRONIC MEMORY FUNCTION”, which is registered as Korean Patent Number 0746927.

The “CONVENTION CARD WITH MULTI-FUNCTIONAL ELECTRONIC MEMORY FUNCTION” discloses the technology using an REID tag and an information storage unit, and stores information of enterprises (countries) or visitors participated in the festival as data in such a manner that the data can be used as a kind of digital entry ticket when holding the exhibition/exposition and various international conferences, or other various cultural events, thereby enabling scientific control and information management.

However, according to the above patent, the external structure of a product is limited to only a simple card type structure. Thus, the application of the product in terms of hardware is limited within the function of an entry ticket for allowing or restraining entrance to an event place and a data storage medium for collecting a series of event information. That is, the product has no special functions and utilities so the product is very limited in use.

Meanwhile, the “CONVENTION CARD WITH MULTI-FUNCTIONAL ELECTRONIC MEMORY FUNCTION” is very effective and useful in the place where the entrance and the exit are essentially provided to strongly control and manage the entrance of visitors and corporations participated in the event, such as a convention center, an exhibition center, or an exposition hall having a limited space. However, in the case of the local festival, which is carried out without fences and in which various paid and free events are simultaneously carried out in various places during the designated period and commercial corporations in the region of the local festival are temporary event participation corporations for obtaining the profit in that local area, the convention card with the multi-functional electronic memory function is very limited in use, and, in an extreme case, the convention card may not be used due to the problem in functions thereof.

### SUMMARY OF THE INVENTION

The present invention has been made in view of the above problems according to use of a multi-functional convention card of the related art, and an object of the present invention is no provide a system far operating an event using a multi-functional character souvenir and a method for operating an event using the same, in which the external structure of a multi-functional convention card including an RFID tag and an information storage chip is configured to have a character shape representing a corresponding festival event, for example, a Sancheoneo shape in a case of a Hwacheon Sancheoneo Ice Festival and a butterfly shape in a case of a Hampyung butterfly festival, in such a manner that the multi-functional convention card can be used as an accessory such as a souvenir, a portable phone ring, or a brooch symbolizing the festival as well as a simple convention card, thereby increasing symbolism of the festival and the utility of the multi-functional convention card.

Another object of the present invention is to provide a system for operating an event using a multi-functional character souvenir and a method for operating an event using the same, in which a series of procedures to operate various cultural events, such as exhibitions/expositions and other international conferences, as well as local festivals can be performed by using a character souvenir having an electronic communication control function, a composite reader, and an event operator server for controlling and managing the character souvenir and the composite reader, so that accurate numeric statistical information of festival visitors, profit and loss data derived from the visitors in the festival region, and rank data of the events having high participation and interest of visitors during the festival period can be scientifically obtained, and the management of visitors and the post marketing can be ensured with respect to the visitors after the completion of the festival based on the information about the visitors, thereby enabling the systemic and efficient management for the festival.

In accordance with an aspect of the present invention, a system for operating an event includes: a character souvenir including a Radio Frequency IDentification (RFID) tag device, an information storage chip, an acoustic output device, and a cash charging chip; a composite reader reading and processing information stored in the character souvenir; and an event operator server receiving, storing, and managing the information read and processed by the composite reader.

The method for operating the event using the system for operating the event according to an embodiment of the present invention can be accomplished by sequentially performing an event participation requesting step, a price charge requesting step, an information inputting step, a cash charging step, an event affiliated corporation establishing step, a visitor participation information collecting step, a festival result information processing step, and a post marketing step.

As illustrated above, according to the system for operating the event using the multi-functional character souvenir and the method for operating the event using the same of the present invention, the external structure of the multi- functional, convention card having an electronic memory function is configured to have the shape of various character souvenirs representing the festival, so that the multi-functional convention card can be used not only as the simple festival entrance ticket, but also as the souvenir symbolizing the festival, thereby increasing symbolism of the festival and the utility of the multi-functional convention card.

In addition, a series of procedures to operate various cultural events, such as local festivals or the like, can be systemically achieved by the character souvenir having the electronic memory and communication functions, the composite reader, and the event operator server managing the character souvenir and the composite reader, so accurate numeric statistical information of the festival events can be obtained and the post marketing is possible with respect to the visitors based on the information, thereby establishing the reasonable and efficient event relationship with respect to the visitors.

### BRIEF DESCRIPTION OF THE DRAWINGS

FIG. 1 is a schematic view illustrating a system for operating an event using a character souvenir according to an embodiment of the present invention.

FIG. 2 is a view illustrating an internal configuration of a character souvenir according to an embodiment of the present invention.

FIG. 3 is a view illustrating an external structure of a character souvenir according to an embodiment of the present invention.

FIG. 4 is a schematic view illustrating an event operator server according to an embodiment of the present invention.

FIG. 5 is a schematic view illustrating a composite reader according to an embodiment of the present invention.

FIG. 6 is a schematic view illustrating a method for operating an event using a system for operating the event according to an embodiment of the present invention

FIG. 7 is a flowchart illustrating a method for operating an event using a system for operating the event according to an embodiment of the present invention.

### DETAILED DESCRIPTION OF THE PREFERRED EMBODIMENTS

Hereinafter, a system for operating an event and a method for operating the event using the same according to exemplary embodiments of the present invention will be described with reference to accompanying drawings.

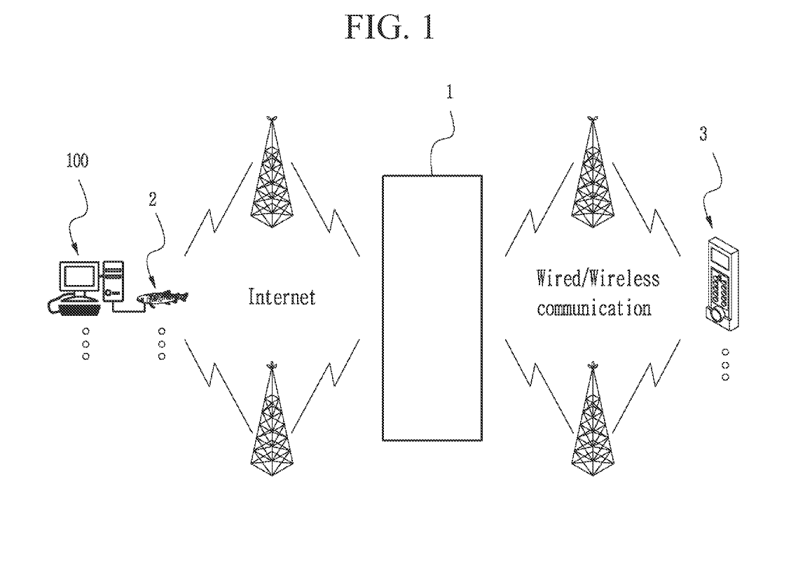

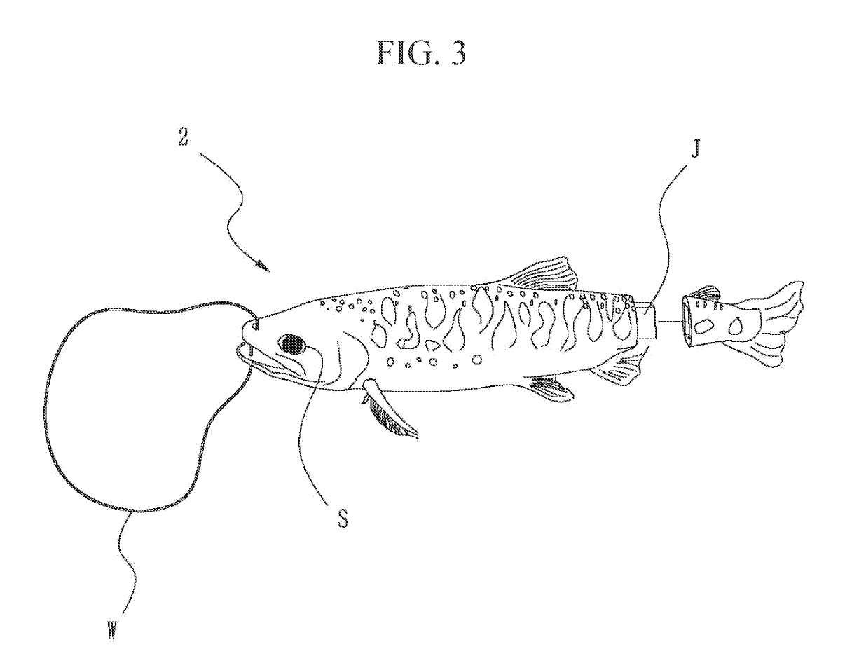

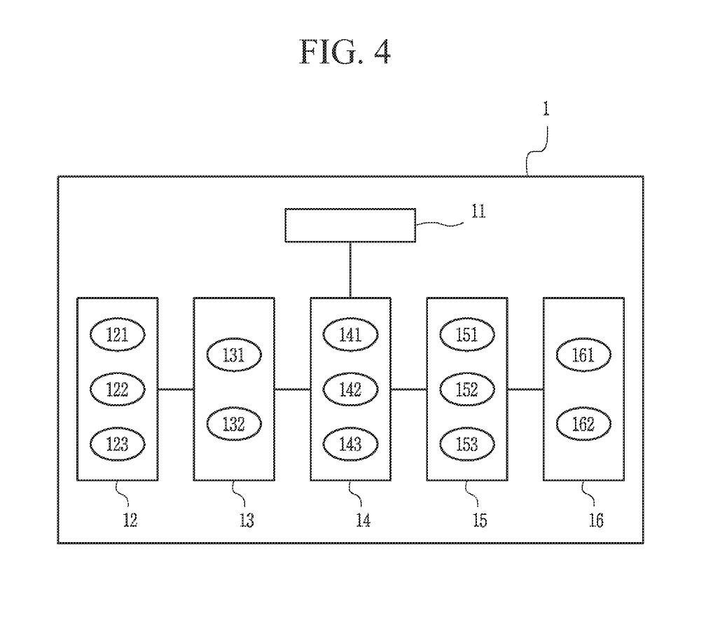

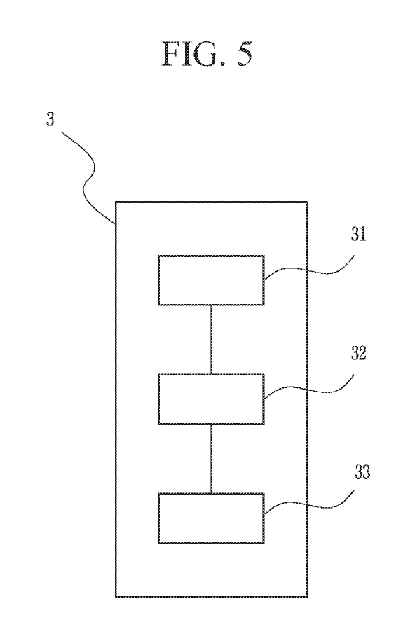

FIG. 1 is a schematic view illustrating a system for operating an event using a character souvenir according to an embodiment of the present invention; 2 is a view illustrating an internal configuration of a character souvenir according to an embodiment of the present invention; FIG. 3 is a view illustrating an external structure of a character souvenir accordion to an embodiment of the present invention; FIG. 4 is a schematic view illustrating an event operator server according to an embodiment of the present invention; and FIG. 5 is a schematic view illustrating a composite reader according to an embodiment of the present invention.

The system for operating the event using the character souvenir according to an embodiment of the present invention includes an event operator server 1, a character souvenir 2, and a composite reader 3.

In the configuration of the system according to an embodiment of the present invention, first, the event operator server 1 is a main web site arrangement according to the present invention provided to plan, manage, operate and propagate a festival event, and includes an automatic information processor 11. In addition, the event operator server 11 may further include a visitor information manager 12, a corporation information manager 13, a cash charger 14, and a statistical processor 15, and a marketing operator 16.

In the event operator server 1, the automatic information processor 11 links an individual visitor server (user) 100 with the event operator server 1 through an Internet in real-time. Further, the automatic information processor 11 is a typical on-line medium that allows the composite reader 3 provided in an event affiliated corporation to be linked with the event operator server 11. The automatic information processor 11 has the configuration and function the same as those of a processor applied to a typical Internet portal server.

Moreover, in the event operator server 1, the visitor information manager 12 is a kind of a data processor for efficiently managing the individual visitor server 100 requesting participation in the festival event. As shown in FIG. 4, the visitor manager 12 is operated in a member participation request mode 121, a member information storage mode 122, or a member information transmission mode 123.

In addition, in the event operator server 1, the corporation information manager 13 is a data processor for storing and managing information regarding various corporations and project event places aiming at the economic profit in the festival event zone, such as restaurants, product shops, lodging facilities, festival exhibitions, and festival related event places. Preferably, the corporation information manager 13 is operated in a corporation information storing mode 131 or a profit information receiving mode 132.

Further, the cash charger 14 of the event operator server 1 creates and provides electronic money to be used in the festival region according to a request from the individual visitor server 100 wishing participation in the festival. Preferably, the cash charger 14 is operated in a settlement mode 141, a settlement money charging mode 142, or an incentive money charging mode 143.

In addition, the statistical processor 14 of the event operator server 1 receives and manages information obtained through the composite reader 3, such as individual visitor information participated in the festival event and settlement information of the visitors. Preferably, the statistical processor 15 is operated in a visitor statistical mode 151, a profit statistical mode 152 for each corporation, or a festival interest, degree statistic mode 153.

Moreover, the marketing operator 16 of the event operator server 1 may induce visitors participated in the festival event such that the visitors are willing to participate in the next festival event. Preferably, the marketing operator 16 is operated in a propagation data generating mode 161 or a propagation data transmission mode 162.

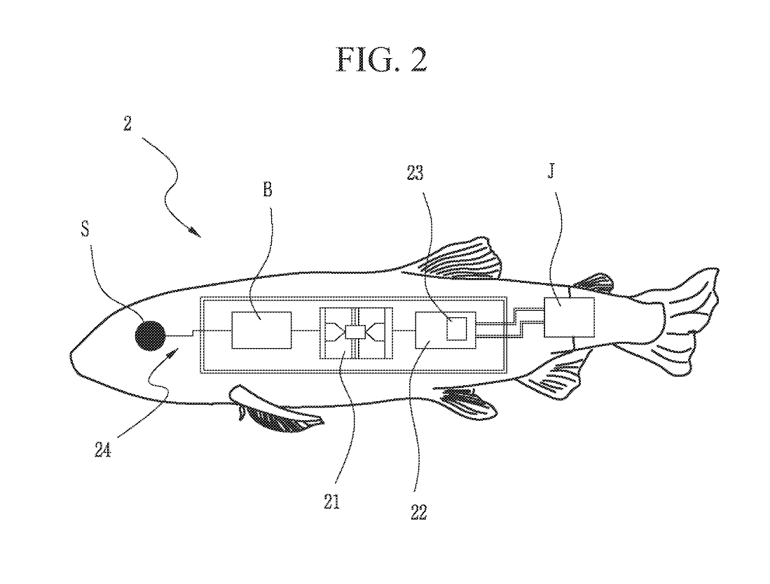

Meanwhile, in the configuration of the system for operating the event, the character souvenir 2 is a kind of a Universal Serial Bus (USB) memory device for performing an electronic memory function, a wireless information communication function, and an acoustic output function. As shown in FIG. 3, the external appearance of the character souvenir 2 is configured to have a character shape representing a corresponding festival event. For example, in a case of a Hwacheon Sancheoneo Ice Festival, the character souvenir 2 is shaped in the form of Sancheoneo, which is a symbol of the festival. Similar to the typical convention card, a Radio Frequency IDentification (RFID) tag device 21 and an information storage chip 22 are installed in the character souvenir 2. In addition to this, as shown in FIG. 2, a cash charging chip 23 and an acoustic output device 24 are preferably provided in the character souvenir 2. Reference numeral J denotes a USB connection jack.

The RFID tag device 21 installed in the character souvenir is defined by a combination of an RFID tag installed/attached to an identified object and an external identifier for recognizing information of the RFID tag from the outside. The external identifier transmits and receives a radio frequency (RF) to and from the RFID tag by using a relatively large antenna, and the RFID tag receives the RF through a relatively small antenna to output identification data. In detail, the RFID tag device 21 according to an embodiment of the present invention has the function and configuration the same as those of a general RFID tag device. Preferably, the RFID tag device 21 includes one-chip with a coder/decoder, a controller, and a memory; and an antenna.

Further, the information storage chip 22 installed in the character souvenir 2 is connected to a private communication unit or a corporation communication unit. (computer, etc.) through the USB connection jack to store and manage various information data provided from communication unit. Preferably, internal/external memory such as a typical USB memory or a SanDisk is selectively applied as the information storage chip 22.

The cash charging chip 23 of the character souvenir 2 is charged with cash to be used in the event region. A cash charging chip applied to an advance payment settlement type traffic card is applied to the cash charging chip 23 as it is.

In addition, the acoustic output device 24 of the character souvenir 2 outputs speech information stored in the information storage chip 22. As shown in FIG. 2, preferably, the acoustic output device 24 is composed of a speaker 5, a battery B, and a playback control button (not shown).

Meanwhile, in more detail, the external structure of the character souvenir 2 having the structure as described above is variably configured as a decoration model symbolizing the subject of the festival event. Accordingly, the modeled character souvenir 2 is a product having a simple electronic memory function and a communication function, and, as shown in FIG. 3, a fixing and connecting means W is provided in one side of the modeled character souvenir 2 so that the modeled character souvenir 2 may be used as a portable product, such as a portable phone ring, a key ring, a brooch, a necklace, a bracelet, a name tag, a body decoration, or the like according to user's selection.

Finally, in the configuration of the system for operating the event according to the present invention, the composite reader 2 reads information of the RFID tag device 21 and the information storage chip 22 of the character souvenir settlement processing information, or the like, and transmits the read information to the event operator server 1. Accordingly, as shown in FIG. 5, preferably, the composite reader 3 includes an information receiver 31 reading stored information of the character souvenir, a settlement processor processing settlement information, and an information transmitter 33 transmitting the stored information read from the character souvenir 2 and the settlement information to the event operator server 1.

Accordingly, system having the configuration mentioned above according to the present invention may realize the distinctive method for operating the event. Hereinafter, the distinctive method for operating the event according to the exemplary embodiment of the present invention will be described in detailed with reference to the accompanying drawings.

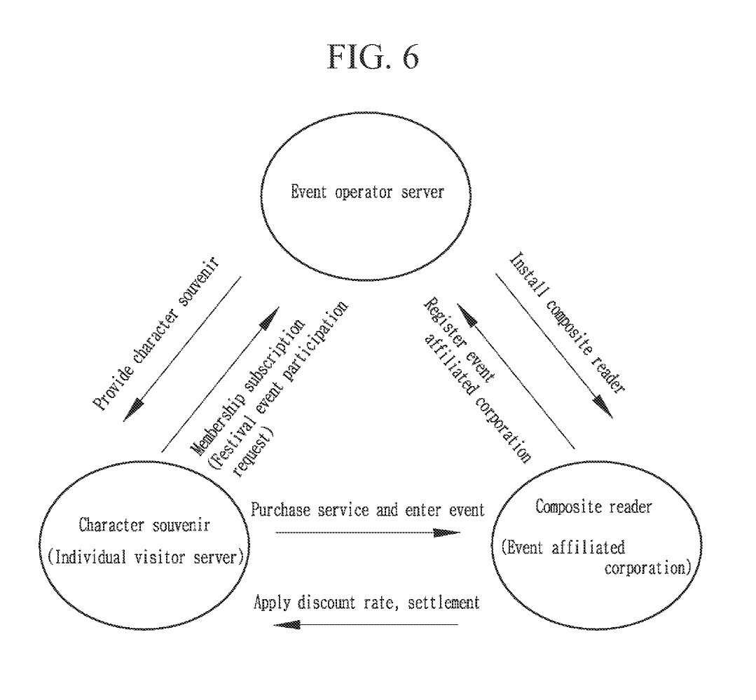

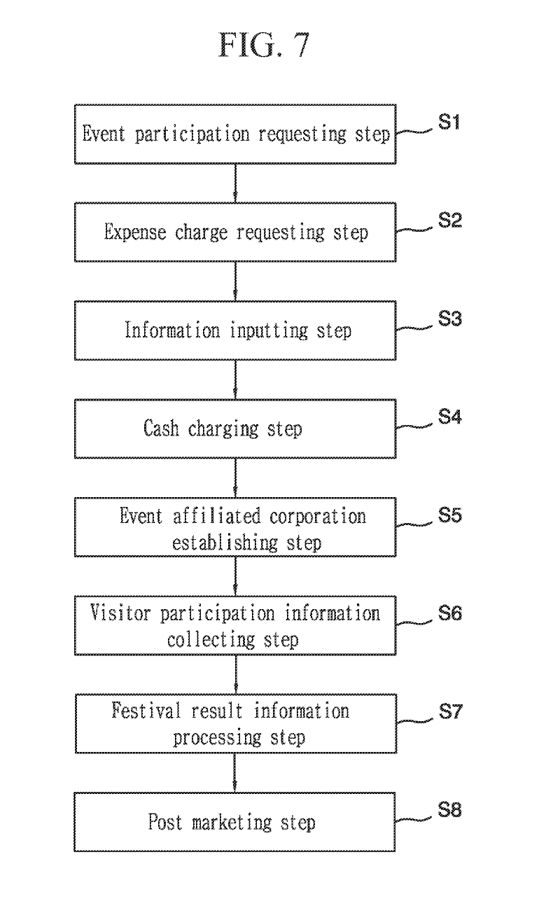

FIG. 6 is a schematic view illustrating a method for operating an event using a system for operating the event according to an embodiment of the present invention, and FIG. 7 is a flowchart illustrating a method for operating an event using a system for operating the event according to an embodiment of the present invention.

The method for operating the event using the system for operating the event according to the embodiment of the present invention is accomplished through an event participation requesting step S1, an expense charge requesting step S2, an information inputting step S3, a cash charging step S1, an event affiliated corporation establishing step S5, a visitor participation information collecting step S6, a festival result information processing step S7, and a post marketing step S8.

Preferably, the event participation requesting step S1 is achieved by linking an event operator server 1, which is the host server of the festival event, with a plurality of unspecified individual visitor servers 100 wishing participation in the event by an automatic information processor 11. For example, when Internet users who are the potential customers attempt to use and access their personal computers, individual visitor servers 100 of the users are linked with the event operator server 1 by the automatic information processor 11, and private information data of visitors are transmitted to the event operator server 1 in response a request from the linked individual visitor servers through a member participation requesting mode 121 of the visitor information manager 12 to issue and assign an identification, a password, and a unique serial participation number (RFID communication identification number) of a member.

In this case, names, sexes, ages, identification numbers, residence places (addresses), mobile phone numbers, and e-mail information of visitors among private information of the visitors must be essentially provided through the member participation requesting mode 121, whereas, others, hobbies, and interest fields may be regarded as optional factors. The membership subscription based on an ID and a password is similar to the membership subscription of a portal site

Next, the expense charge requesting step S2 is to receive charge of an expected cost to be used in the festival by a visitor, for example, an entry fee for an event place, a souvenir purchase fee, a lodging fee, a food fee, a traffic fee, and the like by using an electronic money in an advance payment manner. Preferably, the expense charge requesting step S2 is achieved by selectively receiving input of desired charging cost information to be used in the festival event region from the individual visitor server 100 through a cash charger during the membership subscription request (event participation request) by the individual visitor server 100, and processing the online settlement in advance through a settlement mode 141, for example, on-line transfer account, credit card settlement, or mobile settlement.

In addition, preferably, the information inputting step S3 is achieved by storing the private information data and a unique serial participation number (RFID communication identification number) of the visitor provided in the event participation requesting step S1 in a member information storage mode of a visitor information manager, and transmitting and inputting the stored information to an information storage chip 22 of a character souvenir 2 in a member information transfer mode.

In this case, information such as private information data of a visitor, character information, speech information, dynamic image information propagation contents of a festival event stored in the information storage chip 22 may be selectively input, stored, edited or read by connecting an USB connection lack of a character souvenir to the event operator server 1 and the individual visitor server 100 (PC). In particular, the use may selectively play and listen to the stored speech information through the acoustic output device 24 anytime and anywhere regardless of time and space.

Furthermore, in more detail, the character souvenir including the information storage chip 22 and the RFID tag device 21 is a product having a decorative function providing all festival participation information to a visitor (reception through air mail or visitation) in a state that all festival participation information provided from the individual visitor server 100 is previously stored through the event operator server 1 when an event participation is previously requested through the individual visitor server 100. The character souvenir 2 is a semi-permanent product, so a visitor can always carry the character souvenir 2. When the next festival event is held, the character souvenir 2 may be repeatedly used through correction, edition, and addition of the input and stored information.

Preferably, a cash charging step 34 is to charge and provide the desired charging cost, which is settled through the individual visitor server 100 in the cost charge requesting step 32, in a cash charger 14 of the event operator server 1. That is, the cash charging step S4 is to charge the electronic money in a cash charging chip 23 of the character souvenir 2 through a settlement money charge mode 142.

In this case, the electronic money charged in the cash charge chip 23 may be used at a predetermined discount rate. For instance, when the charged electronic money having the face value of 100,000 won is used in an event region, a discount rate of 5% may applied to all fees (entry fee for paid event place, souvenir purchase fee, lodging fee, food fee, and the like) settled with the electronic money. In another case, when charging the electronic money, a predetermined allotted money can be charged as an incentive money through an incentive money charging mode 143 in addition to a charged money requested from the individual visitor server 100, to express thanks for participating in the event.

Next, preferably, the event affiliated corporation establishing step 35 is achieved by a procedure of communication-connecting a composite reader provided in an event affiliated corporation with the event operator server 1.

In more detail, the event affiliated corporation refers to a subject aiming at an economic profit in a festival event region, for example, all paid event, places associated with a festival, restaurants, product shops, lodging facilities, or the like. When there is a festival participation request (through on-line or off-line) from the event affiliated corporations, the event operator server 1 takes a predetermined sponsor fee and installs a composite reader 3 having an on-line communication relationship in the event affiliated corporations to make an event affiliated relationship. Further, a list of event affiliated corporations having the event affiliated relationship is stored and managed in a database of an event operator server 1 in a corporation information storage mode 131 provided in a corporation information manger 13.

Preferably, the visitor participation information collecting step 36 is achieved by controlling the composite reader 3 to read the character souvenir 2, visitor information input to the RFID tag device 21 and the information storage chip 22 of the character souvenir 2 through an information receiver 31 of the composite reader 3 when a visitor having the character souvenir 2 enters various event affiliated corporations with the composite reader 3 or is provided a paid service through the entry, and inputting corresponding cost history information when there is a paid service cost used by a visitor through a settlement processor 32 of the composite reader 3, performing a settlement processing by using an electronic money charged in the cash charging chip 23, and transmitting serial information to a statistical processor 15 included in the event operator server 1.

Preferably, the festival result information processing step S7 applies visitor information and settlement information provided from the composite reader 3 of the event affiliated corporation to a statistical processor 15 of the event operator server 1 to compute, store, and manage a series of festival results. For instance, in the festival result information processing step S7, information, such as a total number of visitors in a festival event region, a distribution chart of visitors according to the residence place thereof, sexes and ages of visitors, and visiting years and the visiting frequency of the visitors in the festival region, is computed and stored as data based on the transmitted information through a visitor statistical mode 151 of the statistical processor 15. Preferably, in the festival result information processing step S7, expenses of visitors in the festival region and other profit and loss data are computed and stored in a profit statistical mode 152 for each corporation of the statistical processor 15. Preferably, the festival result information processing step S7 computes rank data for each event having high interest and profit and loss data of the festival event in a festival interest statistical mode 153 and stores the resultant data and information.

Finally, the post marketing step S8 is to induce visitors participated in the festival event such that the visitors again participate in the next festival based on the visitor information obtained the event participation requesting step S1 and the festival result information processing step S7. Accordingly, it is preferable that the post marketing step S8 generates festival guide data composed of various types of characters, images, dynamic images, and speech information in a propagation data generating mode provided by the marketing operator 16 in the event operator server 1. Further, it is preferable that the post marketing step S8 transmits the generated festival guide data to an e-mail and a mobile terminal of the festival event visitor in the propagation data transmission mode 162.

As mentioned above, the system for operating an event and the method for operating an event using the same according to an embodiment of the present invention are riot simply limited to a local festival event but is applied to various cultural events and cultural spaces, for example, various exhibitions/expositions, international conferences, large-scale sports events, or museums for efficiently managing and controlling visitors' positions, rapidly and exactly sharing information between an event operator and visitors, and utilizing a series of procedures as a scientific statistical data. The application and utilization of the system and the method according to the present invention can be selectively adopted, and such a selection may not intend to limit the technical scope of the present invention.

What is claimed is:

1. A system for operating an event, system comprising:
a character souvenir including a Radio Frequency IDentification (RFID) tag device, an information storage chip, a cash charging chip, and an acoustic output device;
a composite reader reading and processing data information and cash charging information stored in the character souvenir, and including an information receiver, an information transmitter, and a settlement processor; and
an event operator server receiving, storing, and managing the data information read and processed by the composite reader.

2. The system as claimed in claim 1, wherein an external structure of the character souvenir is variably configured by a decoration model symbolizing a subject of a festival event, and a fixing and connecting unit is provided in a side of a modeled character souvenir so as to allow the character souvenir to be used as a decoration product for a portable phone ring, a key ring, a brooch, a necklace, a bracelet, a name tag, a body decoration, or a portable product.

3. The system as claimed in claim 1, wherein the event operator server includes an automatic information processor, a visitor information manager, a corporation information manager, a cash charger, a statistical processor, and a marketing operator, and achieves an online connection relation with an individual visitor server.

4. A method for operating an event using a system for operating the event, the method comprising:
an event participation requesting step of linking an event operator server with an individual visitor server wishing participation in the event by an automatic information processor, receiving private information data of a visitor in response to a request of the linked individual visitor server to assign an identification, a password, and a serial participation number;
an expense charge requesting step of receiving desired charging cost information to be used in a festival event region from the individual visitor server when participation of the event is requested by the individual visitor server, and processing online settlement of a desired charging cost;
a visitor information data inputting step of storing the private information data and the serial participation number of the visitor in a member information storage mode of a visitor information manager, and transmitting and inputting the stored information to an information storage chip of a character souvenir equipped with a Radio Frequency IDentification (RFID) tag device in a member information transfer mode;
a cash charging step of charging and providing the desired charging cost settled through the individual visitor server in a cash charging chip of the character souvenir as an electronic money through a cash charger of the event operator server;
an event affiliated corporation establishing step of communication-connecting a composite reader provided in the event affiliated corporation with the event operator server, and storing a list, of event affiliated corporation having the composite reader in a database of the event operator server in corporation information storage mode provided in a corporation information manger;
a visitor participation information collecting step of reading visitor information input to the RFID tag device and the information storage chip of the character souvenir through an information receiver of the composite reader, inputting cost history information used by a visitor through a settlement processor and transmitting the cost history information to the event operator server;
a festival result information processing step of calculating and processing visitor information and settlement information provided from the composite reader through a statistical processor of the event operator server, computing a total number of visitors in festival local areas, a distribution chart of visitors according to residence places whereof, rank data for events having high interest and profit and loss data of a festival, event according to settlement information, and storing resultant data in a database;
a post marketing step of transferring propagation message with a schedule and contents of a next festival event to an e-mail and a mobile terminal of the visitor through a marketing operator of the event operator server to induce revisitation based on the visitor information obtained in the event participation requesting step and the festival result information processing step.

5. The system as claimed in claim 4, wherein, in the cash charging step, the event operator server additionally charges an incentive money as a participation price of the festival event as well as a settled money in response to a request from the individual visitor server.

6. The system as claimed in claim 4, wherein, when the event operator server transmits and inputs the private information data and the participation serial number of the visitor to the information storage chip of the character souvenir, the event operator server further inputs and stores guidance speech data guiding the festival event and outputs the stored guidance speech data through an acoustic output device of the character souvenir as speech information.
